(19) United States
(12) Patent Application Publication
(10) Pub. No.: US 2014/0305980 A1
(43) Pub. Date: Oct. 16, 2014

(54) VEHICLE ACCESSORY RETAINING SYSTEM

(71) Applicant: CATERPILLAR INC., Peoria, IL (US)

(72) Inventors: Joseph Every, Peoria, IL (US); Michael Conrad, Metamora, IL (US); Richard Gerberding, Chillicothe, IL (US); Gregory Parsons, Peoria, IL (US); Jared Woodruff, Metamora, IL (US); Mark Ortscheid, Oswego, IL (US); William C. Trimborn, IV, Aurora, IL (US)

(73) Assignee: CATERPILLAR INC., Peoria, IL (US)

(21) Appl. No.: 14/246,637

(22) Filed: Apr. 7, 2014

Related U.S. Application Data
(60) Provisional application No. 61/811,391, filed on Apr. 12, 2013.

(51) Int. Cl. B60R 11/00

(52) U.S. Cl. CPC B60R 11/00; B60R 2011/0042
USPC 224/539

(57) ABSTRACT

A vehicle accessory retaining system including a lug extending upwardly from a floor mat positioned on a floor of a vehicle, the lug being integral with the floor mat and having an opening. The vehicle accessory retaining system may further include a post extending from an accessory and adapted to be received in the opening of the lug to releasably secure the accessory. A socket may define a channel in a sidewall of the accessory for receipt of the lug, the post extending into the channel to engage the lug.

### RELATED APPLICATIONS

This application is based upon and claims the benefit of priority from U.S. Provisional Application No. 61/811,391 by Joseph J. Every et al., filed Apr. 12, 2013, the contents of which are expressly incorporated herein by reference.

### TECHNICAL FIELD

The present disclosure relates generally to a vehicle accessory retaining system and, more particularly, to such a retaining system that utilizes a flexible post adapted to engage anchor lugs in the vehicle.

### BACKGROUND

It is sometimes desirable in a vehicle to secure or retain accessories or personal items against movement. For example, a storage tray or other structure intended to receive and carry items may be secured within the vehicle. An exemplary use of this type of storage tray may be in construction or other off-road work vehicles, where an operator may wish to secure personal items such as keys, phone and containers such as, for example, lunch boxes or coolers, while working in the vehicle. Due to the rough terrain in which these vehicles often operate, it may be important to secure all items in the cab against movement. It may also be beneficial in this type of environment to provide a retaining system that allows for fast and easy removal of the accessory (e.g. storage tray) from the vehicle for cleaning or other purposes.

U.S. Pat. No. 6,505,874 (Issued Jan. 21, 2003) discloses a luggage compartment structure that allows a tray be detachably placed on a floor surface of the luggage compartment on which a luggage mat is spread, or detachably placed on the undersurface of an upper back panel of the luggage compartment. The disclosed tray, however, may not be suitable for all vehicle environments, and particularly may not be suited for use in the cab of a vehicle.

The vehicle accessory retaining system of the present disclosure alleviates one or more deficiencies of the prior art.

### SUMMARY OF THE INVENTION

One aspect of the present disclosure is directed to a vehicle accessory retaining system comprising a lug extending upwardly from a floor mat positioned on a floor of a vehicle, the lug being integral with the floor mat and having an opening. The vehicle accessory retaining system may further comprise a post extending from an accessory and adapted to be received in the opening of the lug to releasably secure the accessory.

Another aspect of the present disclosure is directed to a vehicle accessory comprising: a bottom surface and a plurality of sidewalls extending upwardly from the bottom surface. The vehicle accessory may further include a socket for receiving a lug, the socket formed by a first of the plurality of sidewalls, and a post extending from said first sidewall into a channel defined by the socket. The post may be configured to engage the lug to releasably secure the accessory.

Another aspect of the present disclosure is directed to a storage tray for use in a vehicle cab, the storage tray comprising a bottom surface and a plurality of sidewalls extending upwardly from the bottom surface to define an inner volume and an open upper end. The storage tray may further comprise a first socket formed by a first of said plurality of sidewalls for receipt of a first lug and a first post extending outwardly from said first sidewall and into a first channel defined by the first socket. The first post may be configured to engage the first lug to releasably secure the storage tray and may have a distal surface that defines a distal surface angle relative to a longitudinal axis of the post of between 110° and 130°.

### BRIEF DESCRIPTION OF THE DRAWINGS

FIG. 1 is perspective view of a portion of a vehicle cab showing anchor lugs extending upwardly from a floor surface;

FIG. 2 is an enlarged front view of one of the anchor lugs of FIG. 1;

FIG. 3 is perspective view of a portion of a vehicle cab showing a storage tray secured over the anchor lugs according to the concepts of the present disclosure;

FIG. 4 is a perspective view of a storage tray according to the concepts of the present disclosure;

FIG. 5 is an enlarged view of a portion of the storage tray of FIG. 4 showing a first anchor lug channel;

FIG. 6 is an enlarged view of a portion of the storage tray of FIG. 4 showing a second anchor lug channel; and

FIG. 7 is a section view taken generally along line 7-7 of Fig. X.

### DETAILED DESCRIPTION

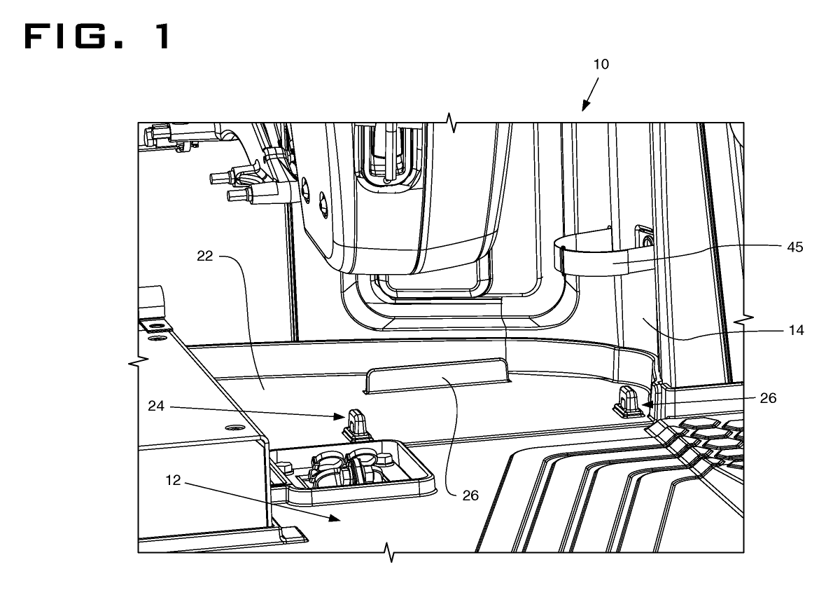

Referring now to FIG. 1, a vehicle cab is shown and is indicated generally by the numeral 10. Vehicle cab 10 may be the cab of any type of vehicle, including, for example, a construction or other work vehicle, such as wheeled loaders, dozers, or compactors, on-highway trucks, and track-type work vehicles. The vehicle cab 10 may provide a location from which an operator can operate the vehicle and may include a door for ingress and egress, an operator seat, operator controls, and one or more windows for visibility. In addition, the operator cab 10 may include a floor surface 12 and sidewalls 14 extending upwardly from a periphery of the floor surface 12. One or more floor mats 22 may be provided over floor surface 12 as a protective covering. Floor mats 22 may be made of any suitable material, such as, for example, woven or polymeric materials.

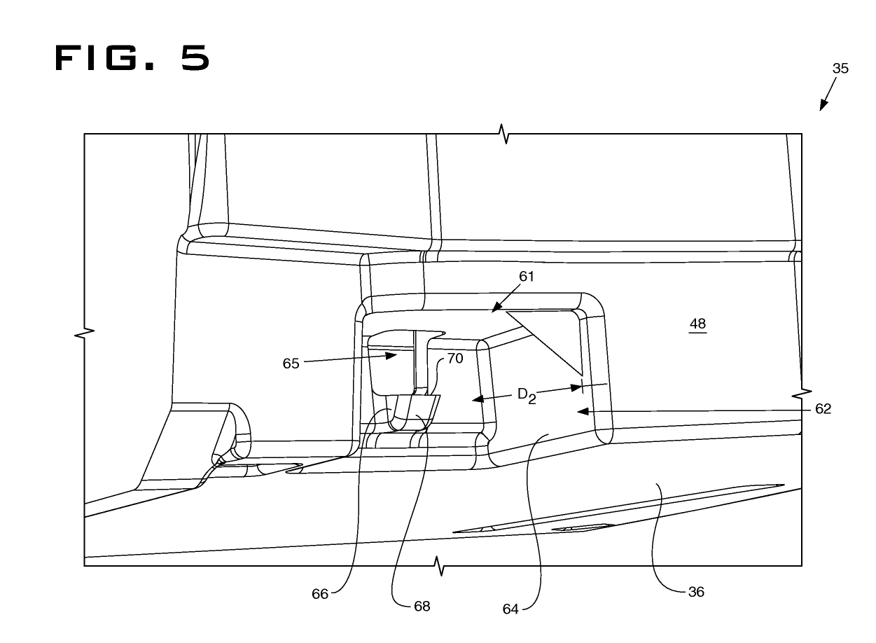

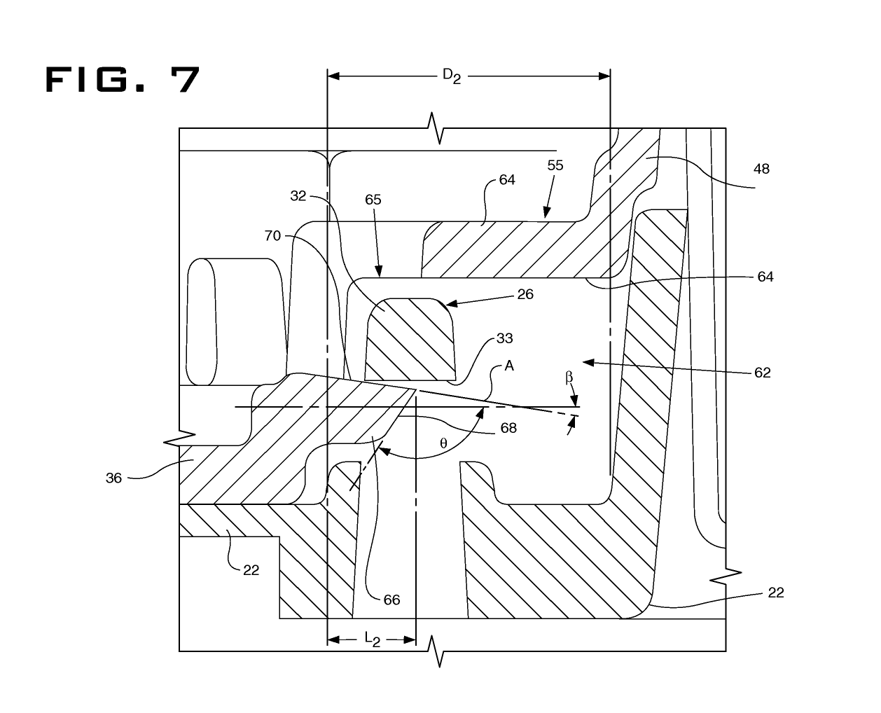

Floor mats 22 may include one or more anchor lugs extending upwardly therefrom. In the embodiment depicted in FIGS. 1-7, a first anchor lug 24 and second anchor lug 26 extend upwardly from floor mat 22, although it should be appreciated that more or less anchor lugs may be provided as necessary or desired in a particular application. Anchor lugs 24 and 26 may be formed integrally with floor mat 22, or may be attached or affixed to the floor mat 22 by other means, including, for example, adhesives and mechanical fasteners. In a particular embodiment, the first and second anchor lugs 24 and 26 may be formed from a flexible and resilient material, such as, for example, polyurethane or other polymeric materials.

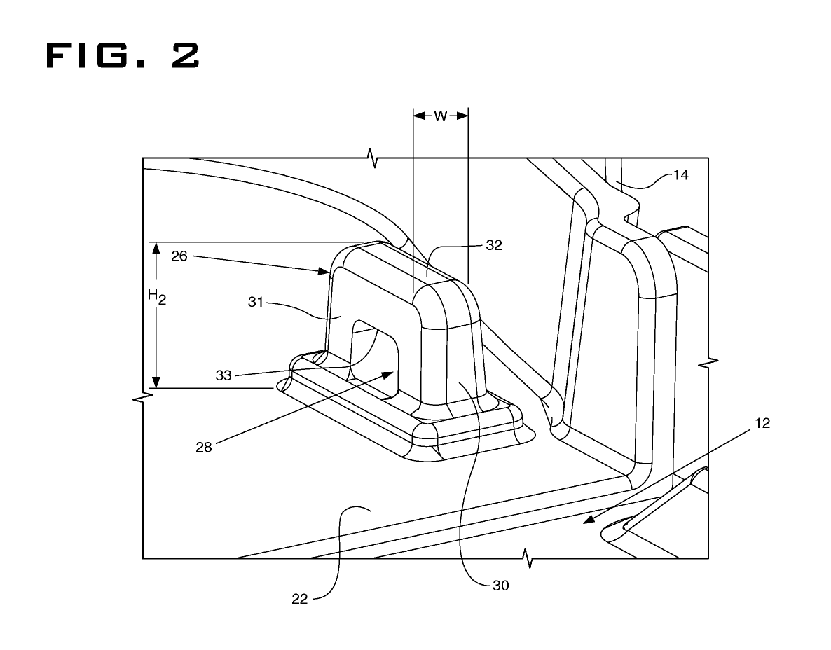

As best shown in FIG. 2, first and second anchor lugs 24 and 26 may have a generally inverted U-shape that defines an opening 28 therethrough. Accordingly, each anchor lug 24, 26 may include a first column 30 and second column 31 laterally spaced from one another, and a distal cross member 32 extending between the first and second columns 31, 32. In a particular embodiment, anchor lugs 24 and 26 may have a tapered sectional profile so that the cross sectional width of the anchor lugs 24, 26 becomes progressively smaller from a base of the first and second columns 30, 31 adjacent floor mat 22 to the distal cross member 32. The spacing and orientation of anchor lugs 24 and 26 may vary, but in a particular embodiment the first and second anchor lugs 24 and 26 may be generally parallel, with the openings 28 positioned on a common axis. First and second anchor lugs 24 and 26 may be substantially identical in size and shape, as shown, or alternatively the first and second anchor lugs may have different geometries.

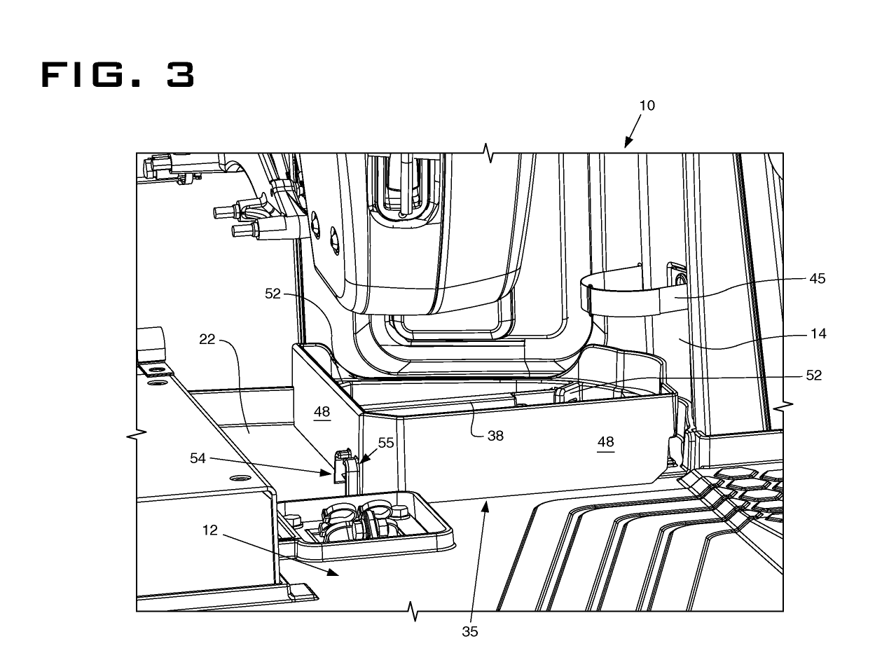

A vehicle accessory may be configured to be retained by the first and second anchor lugs 24 and 26 of floor mat 22. In a particular embodiment, and as shown in FIGS. 3-7 and described herein, the vehicle accessory may be a storage tray 35 configured to be retained within the vehicle cab 10 by anchor lugs 24 and 26. However, while a storage tray 35 is shown and described, it is contemplated that other accessories including, for example, coolers, lunchboxes and other items useful in a vehicle cab may be similarly configured to be retained by the anchor lugs 24 and 26. Accordingly, the term vehicle accessory, as used herein, should be interpreted broadly as an item to be carried within a vehicle unless otherwise stated. It will be appreciated by those skilled in the art that such vehicle accessories may be provided with retention features like those provided in the disclosed storage tray 35 to retain the accessory within a vehicle cab using anchor lugs 24 and 26.

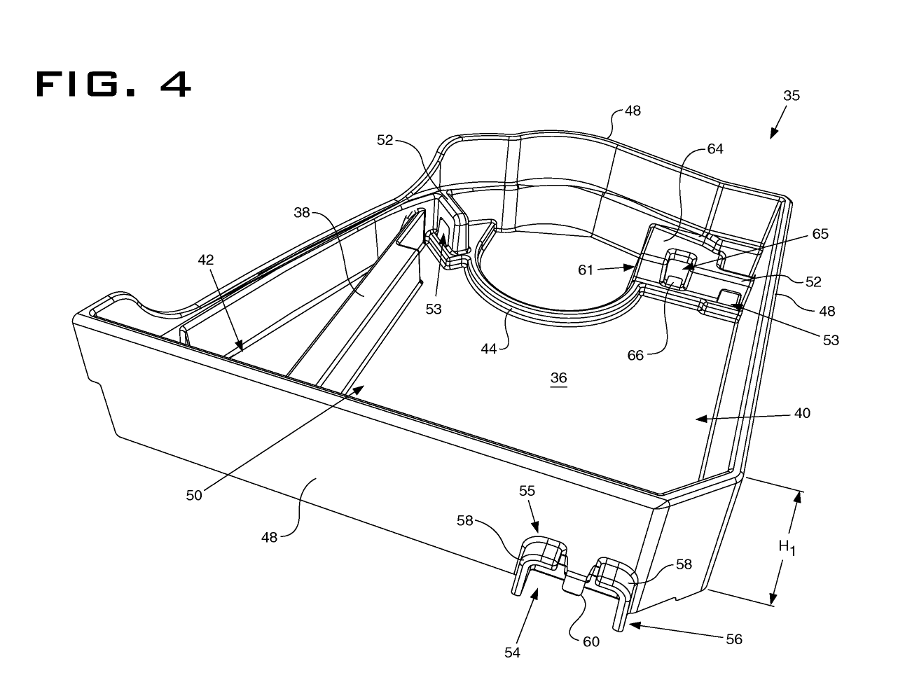

Referring to FIG. 4, storage tray 35 may include a bottom surface 36 configured to rest on floor mat 22. Bottom surface 36 may optionally include a pocket 38 projecting upwardly therefrom to define an opening to receive a rib 39 on floor mat 22. Pocket 38 may also help to separate a first storage area 40 and a second storage area 42 of storage tray 35. Bottom surface 36 may further include one or more upwardly extending ribs 44 defining separate regions for retaining items of a certain size and shape. For example, as shown in FIG. 4, bottom surface 36 may include a rib 44 that has a generally semi-circular profile, the rib 44 being configured to help retain cylindrically shaped items such as, for example, a thermos or fire extinguisher (not shown). A strap 45 (FIGS. 1 and 3) may be carried by a vehicle cab sidewall 14 over the rib 44 to further secure the item against movement.

Storage tray 35 may further include a plurality of sidewalls 48 extending upwardly from a periphery of bottom surface 36. Sidewalls 48 may extend upwardly to any desired height. In a particular embodiment, sidewalls 48 have a height H₁ from bottom surface 36 greater than the height H₂ of anchor lugs 24 and 26. In certain embodiments, the height H₁ of sidewalls 48 may vary around the periphery of storage tray 35. Sidewalls 48 and bottom surface 36 together define an inner volume 50 of storage tray 35, the inner volume having an open upper end. In a particular embodiment, one or more of sidewalls 48 may be contoured to engage a wall other adjacent surface of floor mat 22 and/or floor surface 12 of vehicle cab 10. As shown in FIG. 4, storage tray 35 of the present disclosure includes a pair of generally linear sidewalls 48 that meet at a corner, and a third sidewall 48 extending between the two linear sidewalls with various contours and curves mirroring the sidewall 14 of vehicle cab 10.

Storage tray 35 may include one or more fittings 52 for receiving attachments, such as, for example, a strap or bungee cord. The attachment may be used to further secure items placed within storage tray 35. Each of fittings 52 define an inner opening 53 through which an attachment may be fastened. In a particular embodiment, two or more fittings 52 may be provided so as to provide attachment points for two ends of an attachment.

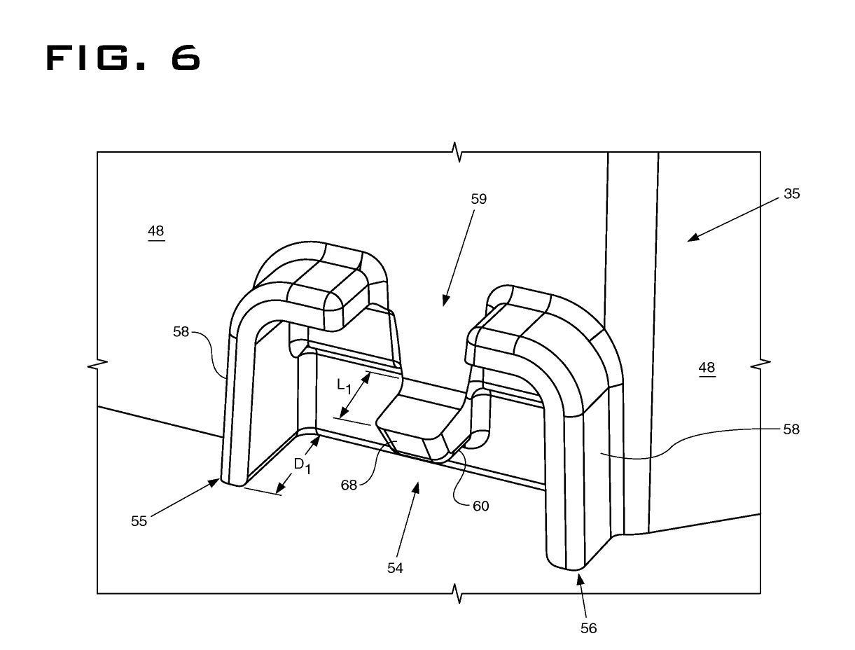

Storage tray 35 includes a first channel 54 defined by a first socket 55 in a sidewall 48 for receipt of anchor lug 24. First socket 55 may be formed by an outwardly projecting canopy 56 in a sidewall 48. Canopy 56 projects outwardly from sidewall 48 a distance sufficient to create a depth D₁ of channel 54 that may be greater than the width W of the anchor lug 24 at the top of cross member 32. Canopy 56 may be formed from a single piece projection or, as shown in FIGS. 4 and 6, by two arcuate projections 58 that are substantial mirror images of one another and laterally spaced to form a gap 59 at a top of canopy 56. The gap 59 may provide access to the anchor lug 24 during installation and removal of storage tray 35.

A first retention post 60 projects outwardly from sidewall 48 into the first channel 54 defined by socket 55. First tray retention post 60 may have a length L₁ that may be less than the depth D₁ of channel 54. In a particular embodiment, the ratio of the depth D₁ of first channel 54 to the Length L₁ of first retention post 60 may be approximately ______. First retention post 60 may be positioned within first channel 54 so that it is received within the opening 28 of anchor lug 24 when anchor lug 24 is positioned within socket 55.

The first retention post 60 may be sized and positioned so that it maintains engagement with a lower surface 33 of the cross member 32 when received in opening 28 of first anchor lug 24. This engagement between the first retention post 60 and the lower surface 33 of cross member 32 when the first anchor lug 24 is received within the first channel 54 prevents movement of the storage tray 35 relative to the first anchor lug 24.

A second socket 61 may be formed in a second sidewall 48 to define a second channel 62 for receipt of anchor lug 26. The second socket 61 may include an inwardly extending projection 64 in the second sidewall 48 that extends inwardly toward the center of storage tray 35. The projection 64 may also extend upwardly from bottom surface 36 of storage tray 35. Second channel 62 may have a depth D₂ that is greater than the width W of the anchor lug 26 at a top surface of cross member 32. An opening 65 through second socket 61 may be provided that allows access to second channel 62 from above storage tray 35. The opening 65 may provide access to the second anchor lug 26 during installation and removal of the storage tray 35.

A second retention post 66 may project into the second channel 62 defined by second socket 61 and may be configured to be received within the opening 28 of anchor lug 26 when anchor lug 26 is positioned within the second channel 62. Second tray retention post 66 may have a length L₂ that is less than the depth D₂ of the second channel 62 in sidewall 48. In a particular embodiment, the ratio of the depth D₂ of second channel 62 to the Length L₂ of second tray retention post 66 may be approximately ______.

The second retention post 66 may be sized and positioned so that it maintains engagement with the lower surface 33 of cross member 32 when received in opening 28 of second anchor lug 26. This engagement between the second retention post 66 and the lower surface 33 of cross member 32 when the second anchor lug 26 is received within the second channel 62 prevents movement of the storage tray 35 relative to the second anchor lug 26.

First and second retention posts 60 and 66 may each have a distal surface 68 spaced from sidewalls 48. The distal surface 68 may face generally outwardly and downwardly from storage tray 35. Each of the distal surfaces 68 may have a distal service angle θ relative to an axis A extending longitudinally through the first and second tray retention posts 60 and 66. The angle θ of distal surface 68 relative to axis A may be between approximately 110° and 130°. In a particular embodiment, the angle θ of distal surface 68 relative to axis A may be approximately 123°.

First and second retention posts 60 and 66 may each also include a top surface 70 that has a top surface angle β relative to axis A extending longitudinally through the first and second tray retention posts 60 and 66. The top surface 70 may face generally upwardly and outwardly away from floor surface 12. The angle β of top surface 70 relative to axis A may be between approximately 4° and 12°. In a particular embodiment, the angle β of top surface 70 relative to axis A may be approximately 8°.

The storage tray 35 presently disclosed includes two sockets 55 and 61 defining channels 54 and 62 to receive the first and second anchor lugs 24 and 26, but more sockets and anchor lugs may be provided as needed or desired. In addition, each of the sockets in the storage tray 35 may include either a canopy 56, as with first socket 55, or an inwardly extending projection 64, as with second socket 61.

Storage tray 35 may be formed from any desired material suitable for use in the intended application. In certain embodiments, the material of storage tray 35 may have a Shore A hardness of less than approximately 100. In a particular embodiment, storage tray 35 may be formed from a urethane material.

### INDUSTRIAL APPLICABILITY

The vehicle accessory of the present disclosure may be useful in any vehicle. The vehicle accessory and retention system disclosed, including storage tray 35, may be particularly useful in construction or other off-road work vehicles. The storage tray 35 may provide a dedicated space for storing personal items and lunch boxes or coolers for an operator of the vehicle, and the retaining system may prevent significant movement of these personal items during operation. The disclosed retaining system may also provide for easy installation and removal of the vehicle accessory (e.g. storage tray 35) for cleaning or other purposes.

Sidewalls 48 provide a storage area within the storage tray 35 and may act to contain items therein. Fittings 52 may allow for use of attachments (e.g. straps or bungee cords) to provide additional resistance against movement of stored items. The channels 54 and 62 formed by sockets 55 and 61, respectively, may protect the retention mechanisms (e.g. first and second anchor lugs 24 and 26 and first and second retention posts 60 and 66) against damage, and may also prevent unintended release of the retention mechanism.

The polymeric materials used to form storage tray 35 may provide a degree of flexibility to the first and second anchor lugs 24 and 26 and the first and second retention posts 60 and 66 to facilitate installation and removal of the storage tray 35. In addition, a polymeric material having a Shore A hardness of less than approximately 100 may help to dampen sounds of items stored within the storage tray 35 moving and rattling during operation of the vehicle.

The angled distal surfaces 68 of the first and second retention posts 60 and 66 may facilitate installation of the storage tray 35 by encouraging the posts to deflect in an upward direction while being inserted into the openings 28 of anchor lugs 24 and 26. Similarly, the angled top surfaces 70 of the first and second retention posts 60 and 66 may facilitate removal of the storage tray 35 by encouraging the posts to deflect in a downward direction while being removed from openings 28 in anchor lugs 24 and 26.

To install storage tray 35, the tray may first be positioned so that second channel 62 is positioned over second anchor lug 26, with second retention post 66 positioned in opening 28 of the second anchor lug. The second anchor lug 26 and/or second retention post 66 may be flexed slightly while positioning the anchor lug within the channel. The tray may then be manipulated so that first channel 54 is positioned over first anchor lug 24, with first retention post 60 positioned in the opening 28 of the first anchor lug. The first anchor lug 24 and/or first retention post 60 may be flexed slightly to allow insertion of the post in the opening of the lug.

Removal of the tray may involve reversing the steps of installation, which may include removing the first retention post 60 from the opening 28 of the first anchor lug 24 by bending the first retention post 60 and/or first anchor lug 24 slightly. Similarly, the second retention post 66 may be removed from the opening 28 of the second anchor lug 26 by bending the second post 66 and/or second anchor lug 26 slightly. Removal of the retention posts 60 and 66 from the openings 28 in the first and second anchor lugs 24 and 26 allows for the storage tray 35 to be lifted away from the anchor lugs.

It will be apparent to those skilled in the art that various modifications and variations can be made to the vehicle accessory retention system of the present disclosure without departing from the scope of the disclosure. Other embodiments will be apparent to those skilled in the art from consideration of the specification. It is intended that the specification and examples be considered as exemplary only, with a true scope of the disclosure being indicated by the following claims and their equivalent.

What is claimed is:

1. A vehicle accessory retaining system comprising:
a lug extending upwardly from a floor mat positioned on a floor of a vehicle, the lug being integral with the floor mat and having an opening;
a post extending from an accessory and adapted to be received in the opening of the lug to releasably secure the accessory.

2. The vehicle accessory retaining system of claim 1, wherein the lug has a generally inverted U-shaped profile defining the opening.

3. The vehicle accessory retaining system of claim 1, wherein the lug is made of a polymeric material.

4. The vehicle accessory retaining system of claim 1, wherein the post has a distal surface that defines a distal surface angle relative to a longitudinal axis of the post of between 110° and 130°.

5. The vehicle accessory retaining system of claim 4, wherein the post has a top surface that defines a top surface angle relative to a longitudinal axis of the post of between 4° and 12°.

6. The vehicle accessory retaining system of claim 1, further comprising:
a socket defining a channel configured to receive the lug, wherein the post extends into the channel.

7. The vehicle accessory retaining system of claim 1, further comprising:
a second lug extending upwardly from the floor mat, the second lug having a second opening, and
a second post extending from the accessory and adapted to be received in the second opening of the second lug.

8. The vehicle accessory retaining system of claim 7, further comprising:
a second socket defining a second channel configured to receive the second lug, wherein the second post extends into the second channel.

9. A vehicle accessory comprising:
a bottom surface,
a plurality of sidewalls extending upwardly from the bottom surface;
a socket for receiving a lug, the socket formed by a first of said plurality of sidewalls; and
a post extending from said first sidewall into a channel defined by the socket, the post configured to engage the lug to releasably secure the accessory.

10. The vehicle accessory of claim 9, wherein the post has a distal surface that defines a distal surface angle relative to a longitudinal axis of the post of between 110° and 130°.

11. The vehicle accessory of claim 10, wherein the post has a top surface that defines a top surface angle relative to a longitudinal axis of the post of between 4° and 12°.

12. The vehicle accessory of claim 9, further comprising:
a second socket for receiving a second lug, the second socket formed by a second of said plurality of sidewalls; and
a second post extending from said second sidewall into a second channel defined by the second socket, the second post configured to engage a second lug.

13. The vehicle accessory of claim 9, wherein the socket includes an inwardly extending projection of said first sidewall.

14. The vehicle accessory of claim 9, wherein the socket includes an outwardly projecting canopy of said first sidewall.

15. A storage tray for use in a vehicle cab, the storage tray comprising:
a bottom surface;
a plurality of sidewalls extending upwardly from the bottom surface to define an inner volume and an open upper end;
a first socket formed by a first of said plurality of sidewalls for receipt of a first lug; and
a first post extending outwardly from said first sidewall and into a first channel defined by the first socket, the first post configured to engage the first lug to releasably secure the storage tray, the first post having a distal surface that defines a distal surface angle relative to a longitudinal axis of the post of between 110° and 130°.

16. The storage tray of claim 15, wherein the storage tray is made of a material having a Shore A hardness of less than 100.

17. The storage tray of claim 15, wherein the storage tray includes at least two fittings for receiving attachments.

18. The storage tray of claim 15, further comprising:
a second socket formed by a second of said plurality of sidewalls for receipt of a second lug; and
a second post extending outwardly from said second sidewall into a second channel defined by the second socket, the second post configured to engage the second lug, the second post having a distal surface that defines a distal surface angle relative to a longitudinal axis of the post of between 110° and 130°.

19. The storage tray of claim 18, wherein the first socket includes an outwardly projecting canopy of said first sidewall and an opening for providing access to the first channel.

20. The storage tray of claim 19, wherein the second socket includes an inwardly extending projection of said second sidewall and an opening for providing access to the second channel.
